(19) United States
(12) Patent Application Publication
(10) Pub. No.: US 2008/0256538 A1
(43) Pub. Date: Oct. 16, 2008

(54) Storage configurations for tessellated virtual machines

(75) Inventors: Stephen R Carter, Spanish Fork, UT (US); Robert A. Wipfel, Draper, UT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/894,384

(22) Filed: Aug. 21, 2007

Related U.S. Application Data
(63) Continuation-in-part of application No. 11/784,869, filed on Apr. 10, 2007.

(51) Int. Cl. G06F 9/46

(52) U.S. Cl. 718/1

(57) ABSTRACT

In a computing environment, an association and layout of virtual machines is provided as a system instantiated for a common computing goal, such as providing a data center with an email system for an enterprise. Irrespective of physical computing devices, a template exists for each of the virtual machines according to a role of the common computing goal, including a definition for external connectivity with other virtual machines. From a template library, certain of the virtual machine templates are selected and tessellated into an application functioning to accomplish the computing goal. Storage configurations contemplate physical storage devices variously arranged over the near and short term relative to each of the virtual machine templates and to the tessellated application as a whole. Managers coordinate, allocate and oversee same.

This application claims priority and benefit as a continuation-in-part application of U.S. patent application Ser. No. 11/784,869, filed Apr. 10, 2007, entitled “Tessellated Virtual Machines for Common Computing Goals,” and having common inventors and assignee, Novell, Inc., the entire contents of which are expressly incorporated herein by reference as if set forth herein.

### FIELD OF THE INVENTION

Generally, the present invention relates to computing system environments contemplative of a virtual machine. Particularly, it relates to pluralities of virtual machines assembled to achieve common computing goals, such as providing an email system for a data center of an enterprise. Tessellated applications establish a computing paradigm for achieving the computing goal according to an entirety of its individual components. Storage configurations relative to the tessellated applications are specific features hereof.

### BACKGROUND OF THE INVENTION

The processes running in a data center, for example, are rapidly becoming more complex as a result of “virtualization.” While virtualizing is solving a myriad of computing problems, the practice is beginning to surface new issues unique to the practice of virtualized data centers having high-density. Further, as regulatory pressures require that data center configurations be certified and regularly re-certified, more and more complex data centers will rapidly overload an enterprise's ability to keep all configurations under control and certified for completeness.

Consider further that single virtual machines are not the end-game in a virtualized data center. Indeed, virtual networks of virtual machines will become more and more prevalent. Consider also an enterprise that has some 50,000 employees with the attendant problems of an email system that large. Rather than configure and maintain a data center with separate email servers, post office servers, IMAP and POP3 servers, SMTP gateways, etc., it would be far easier to have a layout of virtual machines, each caring for one aspect of the email system, linked together virtually and configured to act as the “email system.” Then, when the email system is deployed, each component is instantiated as per the “layout” with the data center personnel not worrying about where each virtual machine is located, how it is communicating with other email virtual machines, etc.

For storage, the process images of a such a system are transitory in nature, but the instantiation is persistent. For example, the aforementioned email system must persist the IMAP or POP3 data or the email would be lost each time the system was shutdown. Even if properly undertaken, immediate and long term control and allocation of resources must be contemplated, to which the present invention is directed. Any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter-described storage configurations for tessellated virtual machines. In a departure from traditional assemblies of computing arrangements, tessellated applications contemplate an entirety of its individual components (e.g., virtual machines) when addressing computing goals and concerns, not just individual components. As its name implies, tessellation provides an arrangement of applications having essentially no overlap or gaps in functionality which together serve the common computing goal.

In a representative embodiment, an assembly of virtual machines exists as a system instantiated for a common computing goal, such as providing a data center with an email system for an enterprise. Irrespective of arrangement or type of physical computing devices, a template exists for each of the virtual machines according to a role of the common computing goal, including a definition for external connectivity with other virtual machines. From a template library, certain virtual machine templates are selected and tessellated into an application functioning to accomplish the computing goal. Storage configurations contemplate physical storage devices variously arranged over the near and short term relative to each of the virtual machine templates and to the tessellated application as a whole. A storage resource manager and one or more storage managers interface with the storage devices to coordinate, allocate and oversee same. Ultimately, tessellated applications provide a new computing paradigm to counter present-day computing complexities and cumbersomeness as systems evolve and become more regulated.

Still other embodiments contemplate computer program products with executable instructions, available as a download or on a computer-readable media, for implementing some or all of the foregoing on one or more physical computing devices.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of representative physical devices in a computing system environment for tessellating virtual machines for common computing goals;

FIG. 2 is a diagrammatic view in accordance with the present invention of a symbol representative of a virtual machine in a computing environment;

FIG. 3 is a diagrammatic view in accordance with the present invention of an assembly of multiple virtual machines in a computing environment;

FIG. 4 is a diagrammatic view in accordance with the present invention of a representative tessellated application of virtual machines for achieving common computing goals;

FIG. 5 is a diagrammatic view and flow chart in accordance with the present invention of a representative tessellation of virtual machines in an application and their attendant storage configurations; and

FIGS. 6A and 6B are diagrammatic views in accordance with the present invention of alternate embodiments of storage configurations, including nested hierarchies.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for storage configurations for tessellated virtual machines are hereinafter described. In a basic sense, tessellation is an association and layout of the virtual machines interacting as a system of virtual machines to achieve common computing goals, such as providing an email system for a data center of an enterprise.

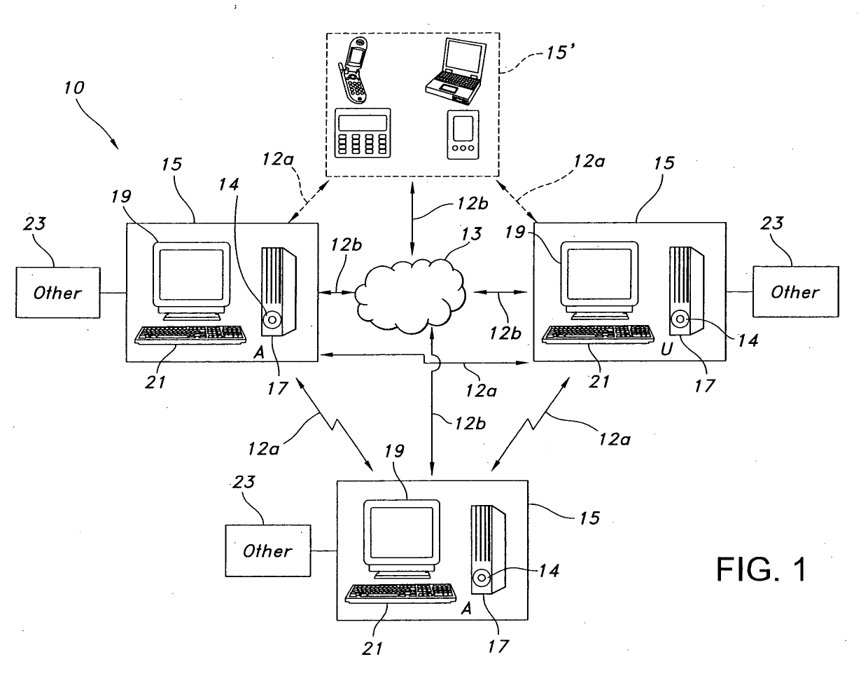

With reference to FIG. 1, a representative environment 10 for tessellation includes one or more physical computing devices 15 or 15′, but their usage as part of one or more virtual machines is irrespective of the physical arrangement or type. In other words, one or more virtual machines may exist per one or more physical computing devices, or as software thereof, but such is largely irrelevant to the ultimately tessellated application.

In a traditional sense, an exemplary computing device exemplifies a server 17, such as a grid or blade server, or peer-to-peer arrangement, hosting applications, web functions, communications, files, etc. Alternatively, an exemplary computing device includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX and LINUX, to name a few, a memory, and a bus that couples various internal and external units, e.g., other 23, to one another. Representative other items 23 (also available for tessellating) include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a server (web, application, communication, IMAP, POP, file, etc.), an AJAX client, a grid-computing node, a peer, a virtual machine, a web service endpoint, a cellular phone or palm device, or the like. The other items may also be stand alone computing devices 15′ in the environment 10.

In either, storage devices (defined in more detail below) are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Storage is representatively provided for aspects of the invention contemplative of tessellated applications as a whole, or in part, and/or computer executable instructions, e.g., code or software, as part of computer program products on readable media, e.g., disk 14 for insertion in a drive of computer 17. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

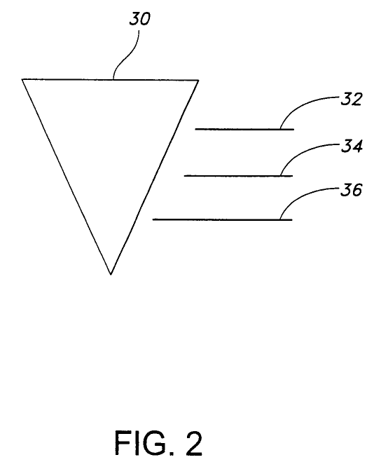

With the foregoing representative computing environment as backdrop, FIG. 2 begins the illustration of tessellation. As a matter of convention beforehand, a symbol or diagram 30, in the form of an inverted triangle, represents a single virtual machine having a role or function in the common computing goal of the pluralities of virtual machines tessellated together. The three lines 32, 34, 36 to the side of the symbol represent the configuration of the virtual machine.

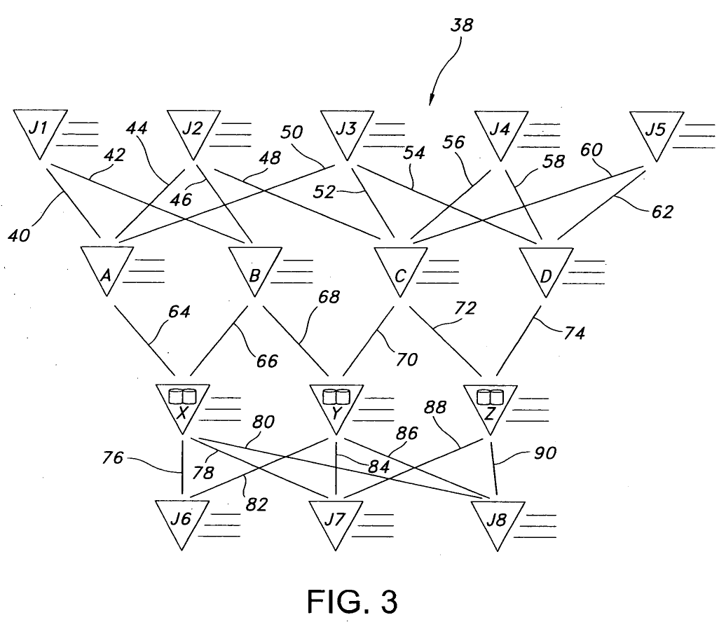

For instance, pluralities of virtual machines 38 in FIG. 3 are further labeled as J1-J8, A-D and X-Z. The configuration of any one virtual machine for achieving the common computing goal of providing an email system, might consist of the virtual machines of A, B, C, and D as end-user email servers, while the virtual machines labeled X, Y, and Z are representative of email post offices. The J1 through J8 virtual machines are representatively various gateways that allow the email system to work (e.g., IMAP, POP, SMTP, Apache, etc.). The configuration, therefore, depends upon what role the virtual machine assumes. That is, if a virtual machine is a POP3 server, its configuration will be that attendant with POP3 functionality and skilled artisans understand its details. Between the various virtual machines are direct or indirect communication lines 40, 42, 44, 46 . . . 90 externally connecting the various virtual machines in some kind of communication channel that performs some function of the common computing goal, e.g., the overarching email system. (Not shown, however, are communication lines that would connect to a WAN or Internet (left out for clarity).)

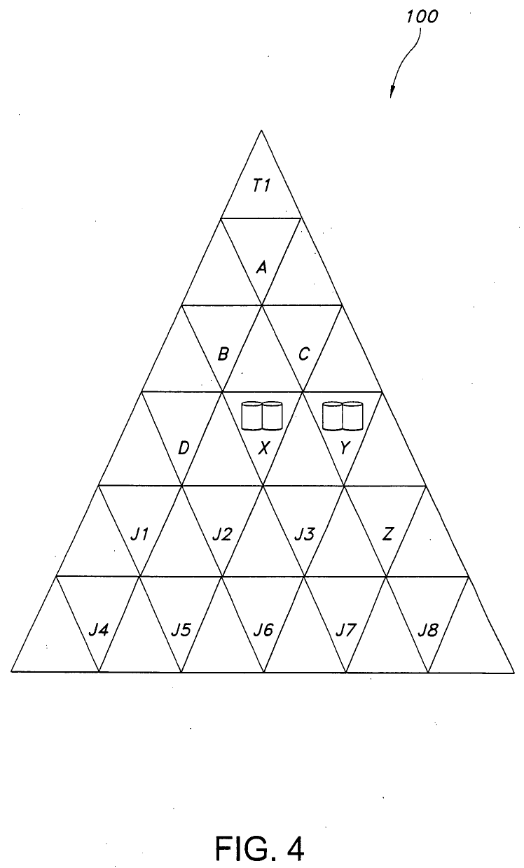

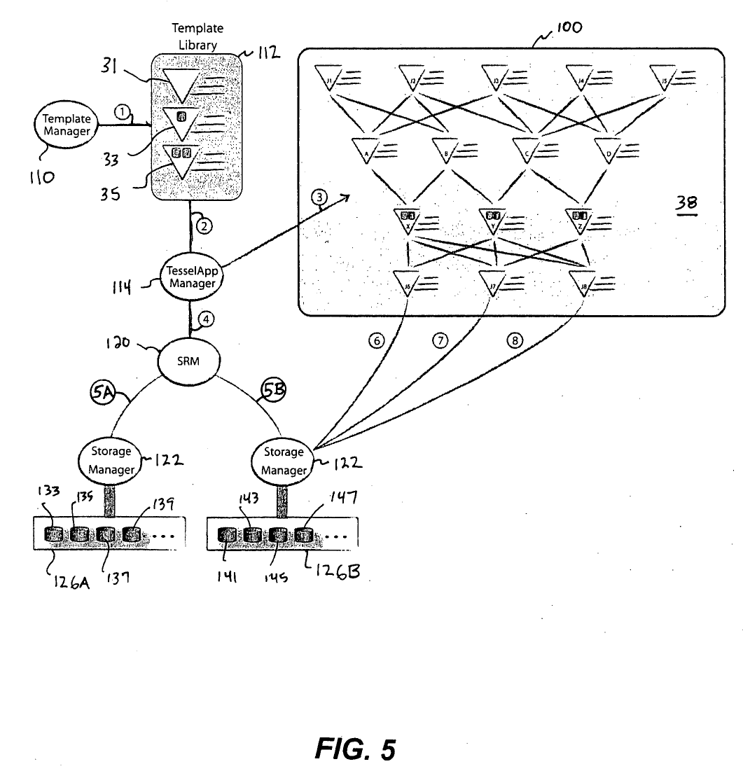

FIG. 4 shows the tessellation T1 or 100 of the virtual machines for accomplishing the common computing goal. In form, it is an application bound together in its entirety that is always considered as an entirety of virtual machines, and not just its individual virtual machine components. In other words, changing only the configuration of virtual machine J3 or virtual machine B is not allowed. Instead, any change or reconfiguration to any part or component of the tessellation 100 requires that the status and functioning of the entire tessellated application be validated and certified for accomplishing the computing goal common to the entirety of virtual machines. In this manner, all of the elements or components needed to instantiate the total tessellated system are held in a single application definition that can be deployed by virtual environment managers. Also, the common computing goal is decentralized which enhances security. It provides flexibility in management as will be seen with regard to FIG. 5.

Namely, a virtual machine template manager 110, such as a system administrator in an enterprise, defines a virtual machine template for each of the virtual machines per a role of the common computing goal. As before, this might consist of defining one virtual machine as a POP3 server, while defining another as an email or IMAP server. Also, this functionality includes defining an external connectivity with other virtual machines and may consist of defining various applications that can be run with the virtual machine. Of course, it is well known how a virtual machine can be configured and associated with virtual disks and content in the virtual disk and physical disks and content in the physical disk. This template mechanism adds to that capability by allowing the definition concerning connectivity to other template definitions concerning network connectivity, SAN connectivity, iSCSI connectivity, etc. The intent then is to declare the needed connections so that each template can be fit into a tessellated application.

Once defined, the template per each virtual machine is compiled with other templates 31, 33, 35 in a template library 112 at step 1. Naturally, many virtual machine templates will exist in the library and can be used for a myriad of computing goals. It is also well to note that the definitions created for the template library can be done via XML or some other descriptive language and that a schema to constrain the specification of the template document is the preferred embodiment.

From here, certain of the templates are selected (step 2) from the library 112 by a tessellation manager 114. At step 3, the tessellation manager tessellates the virtual system 38 according to the existing objective, e.g., the common computing goal. Continuing the example of an email system of a data center, here the administrator concentrates modeling using the templates and external connectivity specifications of IMAP servers, POP servers, etc. To ensure the application works as intended or satisfactorily solves the common computing goal, reference is taken to the incorporated parent-application that teaches validation of the application through various testing.

At step 4, the storage specifications for a tessellated application are contemplated. In general, the process images of an application are transitory in nature, but the storage of the system the application is instantiating is persistent. A storage resource manager (SRM) 120 is vested with control to ascertain, allocate, and otherwise manage the storage configurations. In one embodiment, the SRM contemplates storage requirements for each of the templates 31, 33, 35 in the library. Alternatively, or in addition to, the SRM contemplates storage requirements for the tessellated application 100 as a whole. In either, the SRM directly or indirectly communicates with the tessellation manager 114 who coordinates the information to make decisions regarding tessellation of the templates.

In a representative embodiment of usage, the tessellation application manager 114 uses 4 to obtain from the SRM 120 reference specifications from one or more storage managers 122 (via 5A and 5B). In turn, the storage managers provide access to the physical storage devices 133, 135, 137, 139, etc., (or 141, 143, 145, 147, etc.) for persistent storage 126A, 126B of the application. The storage manager may be as simple as a traditional file system known to the art or a sophisticated SAN, iSCSI or the like.

At steps 6, 7, and 8, the storage configurations are added to the specification of the tessellated application as storage references specific to J6, J7, and J8, for example. Other of the templates could also have storage configurations associated with them if needed. While the discussion has been on persistent storage, it is also possible that a virtual machine in a tessellated application would need temporary storage, such as a very large temporary storage location that would be beyond local storage that might be associated with a virtual machine (as shown below in data canisters in X, Y, and Z). In such a situation, the storage link would be to non-persistent storage in the storage manager (e.g., the virtual machine may require many tera bytes of scratch storage for image manipulation which would be released back to the storage manager upon termination of the virtual machine or the tessellated application itself). In still another embodiment, a newly configured tessellated application would be instantiated that would require the SRM to create new persistent storage locations (e.g., the creation of a new email system that needed storage to start the business of providing email).

In still other embodiments, the specifications of the storage requirement might relate as: 1) precise or crude declarations of a minimum or maximum amount of storage; 2) whether specified storage requirements can be met before undertaking the common computing goal of the tessellated application; 3) temporary storage; 4) exact locations in precise physical storage devices; 5) time-dependent storage that contemplates both near and long term scenarios, and/or an update of the storage requirement over time; or 6) declarations regarding optional storage components. Such can also be logged, for auditing, troubleshooting, and/or other reasons.

As examples of the foregoing, minimum or maximum declarations allow the SRM to understand whether enough physical resources exist for storage. In the event there are insufficient resources, it gives the SRM an opportunity to reallocate existing configurations and/or seek more capabilities. If there are sufficient resources, on the other hand, the SRM can plan for future storage events. Appreciating these declarations provide future computing knowledge, the SRM is also made aware of whether the common computing goals can be achieved by the tessellated application. For instance, if five tera bytes of temporary storage are needed, but only three tera bytes exist until some future time, say tomorrow, the SRM understands the operation of the tessellated application will fail today. The SRM can then delay the tessellated application until tomorrow, where it will not fail. This can also be communicated to the tessellation application manager, whereby potentially other templates (having a storage requirement of less than the three tera bytes available today) might be selected from the library for a given application to create a fully-functioning application today, instead of waiting until tomorrow. In this same vein, skilled artisans will also understand how knowing exact locations and optional storage requirements will further arm the SRM with information useful in the computing system environment.

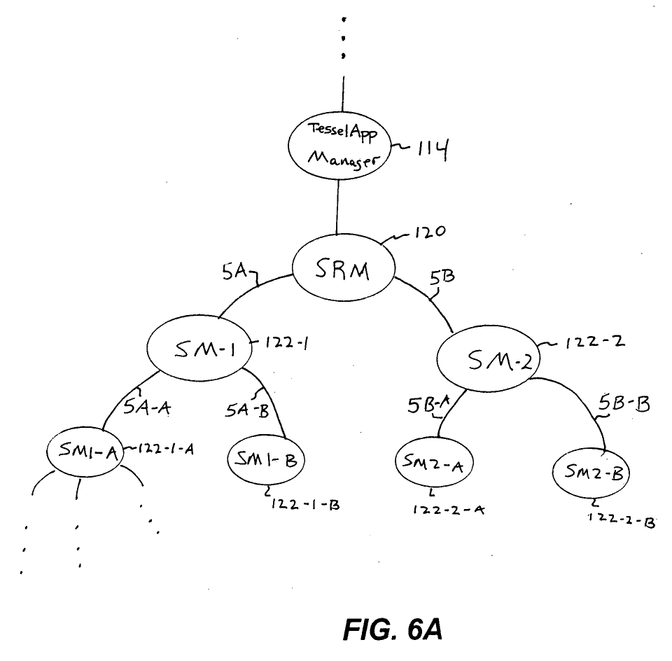

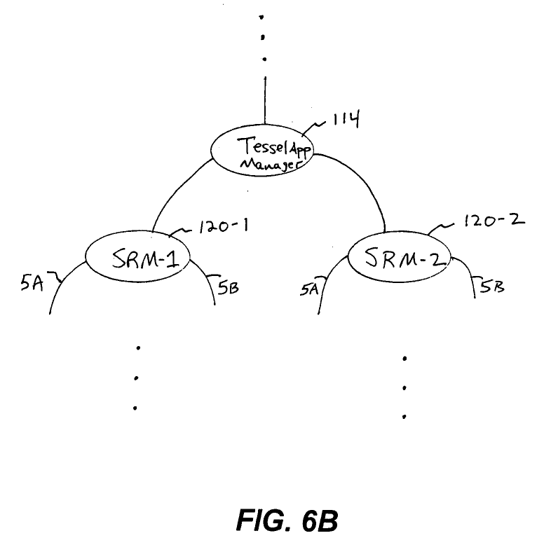

Appreciating the foregoing is a single representative instance of an arrangement of managers and storage devices, nested hierarchies are also possible. For example, FIG. 6A shows a single SRM 120, with various storage managers (SM) 122-1, 122-2, having management hierarchy over still other storage managers SM1-A, SM1-B and SM2-A, SM2-b, respectively, and so on. In FIG. 6B, alternatively, a single tessellation application manager 114 might communicate with multiple SRM's, 120-1, 120-2 who, in turn, may communicate with various storage managers according to earlier embodiments. In either, this gives command and control of storage configurations to certain storage resource managers (SRMs) and/or storage managers (SMs) for functional reasons, such as to allocate roughly the same amount of resources per SM, to prevent bottlenecks in communication between managers, or to distribute storage for security reasons (e.g., to confound attacks), to name a few. Alternatively, it gives the opportunity to distribute tessellated application functionality along similar lines (e.g., those templates relating to IMAP servers may be housed under the existence of a single SRM (or SM) while those templates relating to POP servers may be housed under the existence of another SRM (or SM), for example). Of course, other hierarchies are possible. For example, the notions of FIGS. 6A and 6B can be combined with one another, storage resource managers may be interspersed at various layers between various storage managers and so only indirectly communicate with the tessellation application manager, or some embodiments may find it useful to arrange a layer of one or more primary SRMs above a layer of one or more secondary SRMs having limited responsibilities.

Regardless of form, skilled artisans will appreciate the foregoing enables configuration with policy or governance statements concerning the allowable deployment configuration. Examples of such include, but are not limited to: insistence that certain parts of the application run in a same subnet; describing or declaring which parts or components of the application might be optional (e.g., if a data center does not have enough resources to deploy an entire application, which parts are required); declaring which portions of the application that may be remote from other portions of the application; or the like.

Certain advantages of the invention over the prior art should now be readily apparent. For example, tessellated applications provide a new computing paradigm that counter present-day computing complexities and cumbersomeness that embrace system evolution and regulation. Also, the invention assembles pluralities of virtual machines to achieve computing goals common to the entirety of the machines, not just to an individual machine. Nuances contemplate various libraries, managers, and their interaction and roles. Storage configurations tied with the templates and/or the entirety of tessellated application are other exemplary features, to name a few.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. A method of configuring storage for virtual machines assembled together as a system instantiated for a common computing goal, comprising:
defining a virtual machine template for each of said virtual machines per a role of the common computing goal;
tessellating said virtual machines together according to a defined external connectivity per each said virtual machine template; and
specifying a storage requirement for the each said virtual machine template.

2. The method of claim 1, wherein the specifying the storage requirement further includes specifying a minimum amount of storage.

3. The method of claim 1, further including ascertaining whether the specified storage requirement can be met before undertaking the common computing goal.

4. The method of claim 1, wherein the specifying the storage requirement further includes ascertaining a need for any temporary storage.

5. The method of claim 1, further including vesting control of the storage requirement to a storage resource manager.

6. The method of claim 5, further including vesting control of the tessellating said virtual machines together to a tessellation application manager, the storage resource manage and the tessellation application manager communicating directly with one another.

7. The method of claim 1, further including nesting a hierarchy of storage resource managers controlling the storage requirement.

8. A computer program product having executable instructions for performing the steps of claim 1.

9. A method of configuring storage for virtual machines assembled together on a plurality of physical computing devices as a system instantiated for a common computing goal, comprising:
irrespective of an arrangement or type of the physical computing devices, defining a virtual machine template for each of said virtual machines per a role of the common computing goal, including defining an external connectivity with other said virtual machines per each said virtual machine template;
tessellating said virtual machines together according to the defined external connectivity; and
predetermining a storage requirement according to the physical computing devices for the each said virtual machine template.

10. The method of claim 9, wherein the predetermining the storage requirement further includes specifying exact locations for storage.

11. The method of claim 9, further including vesting control of the predetermining storage requirement to a storage resource manager.

12. The method of claim 11, further including vesting control of the tessellating said virtual machines together to a tessellation application manager, the storage resource manage and the tessellation application manager communicating directly with one another.

13. The method of claim 9, further including updating the storage requirement over time.

14. The method of claim 9, further including nesting a hierarchy of control in managing the predetermined storage requirement.

15. A storage configuration for a network of virtual machines assembled together as a system instantiated for a common computing goal, comprising:
a template library storing a defined virtual machine template for each of said virtual machines per a role of the common computing goal, including a defined external connectivity with other of said virtual machines;
a tessellation application manager to select certain of said defined virtual machine templates from the library for assembly into an application accomplishing said common computing goal;
a plurality of physical storage devices; and
a storage resource manager to ascertain how the storage devices will store each said defined virtual machine template, the storage resource manager to communicate with the tessellation application manager.

16. The storage configuration of claim 15, further including a plurality of storage managers connected between the storage resource manager and the storage devices.

17. The storage configuration of claim 16, wherein the storage managers are one of a file system, a SAN, and a iSCSI.

18. The storage configuration of claim 15, further including a second storage resource manager.

19. The storage configuration of claim 15, further including declarations regarding optional storage components.

20. The storage configuration of claim 15, further including a declaration between said virtual machines and a plurality of physical computing devices.

21. The storage configuration of claim 15, further including a computer program product having computer executable instructions to implement the storage resource manager on one or more physical computing devices.

22. The storage configuration of claim 18, further including a plurality of storage managers connected between the storage devices and one of the storage resource manager and the second storage resource manager.

23. A storage configuration for a network of virtual machines assembled together as a system instantiated for a common computing goal, comprising:
a template library storing a defined virtual machine template for each of said virtual machines per a role of the common computing goal, including a defined external connectivity with other of said virtual machines;
a tessellation application manager to select certain of said defined virtual machine templates from the library for assembly into an application accomplishing said common computing goal;
a plurality of physical storage devices;
a storage resource manager to ascertain how the storage devices will persistently store each said defined virtual machine template, the storage resource manager to communicate with the tessellation application manager; and
a plurality of storage managers connected between the storage resource manager and the storage devices, the storage managers to communicate with the storage resource manager.
